(19) United States
(12) Patent Application Publication
(10) Pub. No.: US 2025/0193490 A1
(43) Pub. Date: Jun. 12, 2025

(54) ASYNCHRONOUS UPDATES FOR MEDIA ITEM ACCESS HISTORY EMBEDDINGS

(71) Applicant: Google LLC, Mountain View, CA (US)

(72) Inventors: Liang Liu, Santa Clara, CA (US); Diego Uribe Mora, San Francisco, CA (US); Junjie Shan, Mountain View, CA (US); Xinyang Yi, Mountain View, CA (US); Jiaxi Tang, Mountain View, CA (US); Shuchao Bi, Mountain View, CA (US)

(21) Appl. No.: 18/968,169

(22) Filed: Dec. 4, 2024

Related U.S. Application Data
(60) Provisional application No. 63/608,098, filed on Dec. 8, 2023.

(51) Int. Cl. H04N 21/4627; H04N 21/466

(52) U.S. Cl. CPC H04N 21/4627; H04N 21/4667

(57) ABSTRACT

Methods and systems for asynchronous updates for media item access history embeddings are provided herein. An embedding that represents a media item access history associated with a client device with respect to a first set of media items previously accessed by the client device is identified. A determination is made of whether one or more embedding relevance criteria are satisfied with respect to the media item access history of the client device. Responsive to a determination that the one or more embedding relevance criteria are satisfied, a media item is selected of a second set of media items not yet accessed by the client device based on the embedding. The client device is provided with access to the selected media item.

### CLAIM OF PRIORITY

The present application claims the benefit under 35 U.S.C. § 119(e) of U.S. Provisional Patent Application No. 63/608,098 filed Dec. 8, 2023, which is incorporated by reference herein.

### TECHNICAL FIELD

Aspects and implementations of the present disclosure relate to asynchronous updates for media item access history embeddings.

### BACKGROUND

A platform (e.g., a content sharing platform, etc.) can enable to users share content with other users of the platform. For example, a user of the platform can provide a media item (e.g., a video item, etc.) to the platform to be accessible by other users of the platform. The platform can include the media item in a media item corpus of which the platform selects media items for sharing with users based on user interest. In some systems, a platform can identify one or more media items (e.g., from the media item corpus) that a user may be interested in. The platform may identify the one or more media items of interest to a user based on other media items that the user may have accessed and/or how the user engaged with (e.g., liked, disliked, skipped, shared, etc.) the other media items. In some instances, a user may access a significant number of media items (e.g., tens, hundreds, etc.) in a particular time period (e.g., an hour, a day, etc.). Identifying new media items that may be of interest to a user based on large media item access history can be time consuming and/or resource intensive for the platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for asynchronous updates for media item access history embeddings. The method includes identifying an embedding that represents a media item access history associated with a client device with respect to a first set of media items previously accessed by one or more client devices associated with a user. The method further includes determining whether one or more embedding relevance criteria are satisfied with respect to the media item access history of the client device. The method further includes, responsive to determining that the one or more embedding relevance criteria are satisfied, selecting a media item of a second set of media items not yet accessed by the client device based on the embedding. The method further includes providing the client device with access to the selected media item.

In some implementations, determining whether the one or more embedding relevance criteria are satisfied with respect to the media item access history of the client device includes at least one of: determining whether a difference between prior media item engagement data associated with the client device and current media item engagement data associated with the client device falls below a threshold difference, determining whether a current time period corresponds to an expected media item access time period for the client device based on the media item access history of the client device, determining whether a number of media items accessed by the client device after generation of the identified embedding falls below a threshold number of media items, determining whether a number of requests to update an embedding associated with the client device falls below a threshold number, or determining whether metadata for the embedding indicates that the identified embedding is invalid

In some implementations, determining whether a difference between prior media item engagement data associated with the client device and current media item engagement data associated with the client device falls below a threshold difference includes extracting, from the prior media item engagement data, one or more of a prior endorsement metric indicating a number of the first set of media items endorsed by the user, or a prior disapproval metric indicating a number of the first set of media items disapproved by the user. The method further includes extracting, from the current media item engagement data, one or more of a current endorsement metric indicating a number a third set of media items endorsed by the user, the third set of media items accessed between the current time period and a prior time period during which the embedding was generated, or a current disapproval metric indicating a number of the third set of media items disapproved by the user. The method further includes determining whether at least one of: a difference between the current endorsement metric and the prior endorsement metric falls below the threshold difference, or a difference between the current disapproval metric and the prior disapproval metric falls below the threshold difference

In some implementations, determining whether a current time period corresponds to an expected media item access time period for the client device based on the media item access history of the client device includes identifying, for each of the first set of media items, a timestamp indicating a time during which the client device accessed the respective media item. The method further includes determining the expected media item access time period based on a range of the timestamps identified for each of the first set of media items. The method further includes determining whether at least one of: the current time period falls within the expected media item access time period, or a distance between the current time period and one or more of the range of the timestamps falls below a threshold distance.

In some implementations, the method further includes responsive to determining that the one or more embedding updated criteria are not satisfied, identifying media item access history data associated with a third set of media items accessed by the client device since the embedding was generated. The method further includes generating an updated embedding based on the identified media item access data. The method further includes selecting an additional media item of the second set of media items not yet accessed by the client device based on the embedding.

In some implementations, the media item access data includes at least one of an identifier associated with one or more of the third set of media items, a duration of access to the one or more of the third set of media items by the client device, a category associated with the one or more of the third set of media items, one or more characteristics associated with content of the one or more of the third set of the media items, an indication of one or more user interactions with respect to the one or more of the third set of media items by a user associated with the client device, or an indication of one or more user reactions with respect to one or more of the third set of media items by the user.

In some implementations, selecting the media item of the second set of media items not yet accessed by the client device based on the identified embedding includes providing the embedding as an input to an artificial intelligence (AI) model. The method further includes obtaining one or more outputs of the AI model. The one or more outputs include, for each of the second set of media items, engagement data indicating one or more of a user interaction with a respective media item of the second set of media items by a user of the client device or a user reaction with the respective media item. The method further includes identifying, based on the obtained one or more outputs, the respective media item associated with engagement data that satisfies one or more engagement criteria.

In some implementations, the method further includes obtaining media item access data for at least a portion of the first set of media items. The method further includes providing the obtained media item access data as input to an AI model. The method further includes obtaining one or more outputs of the AI model. The one or more outputs include one or more embeddings and, for each of the one or more embeddings, a level of confidence that a respective embedding corresponds to the media item access history associated with the client device. The method further includes extracting, from the one or more outputs, the embedding having a level of confidence that satisfies one or more confidence criteria. The method further includes storing the extracted embedding at a region of a memory associated with the client device. The embedding is identified at the region of the memory.

In some implementations, the media item of the second set of media items is further selected responsive to a request received from the client device to access one or more media items.

In some implementations, the selected media item includes at least one of a short-form video item or a long-form video item.

In some implementations, the second set of media items is associated with a first content sharing platform and each of the first set of media items is associated with at least one of the first content sharing platform or one or more second content sharing platforms.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram including an example embedding engine and an example media item engine, in accordance with implementations of the present disclosure.

FIG. 3 depicts a flow diagram of an example method for asynchronous updates for media item access history embeddings, in accordance with implementations of the present disclosure.

FIG. 4 is a block diagram including an example predictive system, in accordance with implementations of the present disclosure.

FIG. 5 is a block diagram illustrating an exemplary computer system, in accordance with implementations of the present disclosure.

### DETAILED DESCRIPTION OF THE DRAWINGS

Aspects of the present disclosure generally relate to asynchronous updates for media item access history embeddings. A platform (e.g., a content sharing platform) can enable users to share media items (e.g., a video item, an audio item, etc.) with other users of a platform. The platform can maintain a data store (e.g., a media item corpus) that includes a significantly large number of media items (e.g., thousands, millions, etc.) available to platform users. In some instances, a platform can identify media items (e.g., of the media item corpus) that may be of interest to a user and can provide the identified media items for access by the user (e.g., via a client device). The platform may determine whether a media item may be of interest to a user based on a media item access history associated with the user. The media item access history can include or can otherwise correspond to media items previously accessed via one or more client devices associated with the user and/or a user engagement with such media items. User engagement can include, but is not limited to, a duration of time that the user accessed the media item, whether the user endorsed (e.g., “liked”) or did not endorse (e.g., “disliked”) the media item, whether the user shared the media item with other users of the platform, whether the user requested to save the media item (e.g., at a region of memory associated with the user) for future access by the user, and so forth. The platform can generate or otherwise obtain media item access history data that represents, for one or more media items previously accessed by the client device associated with the user, features or characteristics for the previously accessed media items (e.g., a category or type of content of the media items, visual features of the media items, etc.) and the obtained user engagement data. In some instances, the platform can compare the features or characteristics of the previously accessed media items (e.g., represented by the media item access history data) to features or characteristics of media items that the user has not yet accessed (e.g., of the media item corpus) to identify media items that may be of interest to the user.

In some systems, a platform may use or otherwise implement machine learning techniques to identify media items (e.g., of the media item corpus) that may be of interest to a user. For example, the platform can generate an embedding that represents the media item access history of one or more client devices associated with the user (referred to herein as a media item access history embedding). An embedding refers to a low-dimensional representation of high-dimension data. In some instances, an embedding can include a low-dimensional, continuous vector representation of variables that can be translated to high-dimensional vectors that reflect or otherwise include a significant amount of detailed data. Embeddings can capture and encode relationships, semantic meanings, or patterns inherent in the data that the embeddings are based on. The platform can generate or otherwise obtain a media item access history embedding for a client device based on media item access history data. In some instances, the embedding can be a low-dimensional representation (e.g., a low-dimensional vector) that is translated from a significant amount of media item access history data associated with the one or more client devices (e.g., data associated with hundreds or thousands of media items most recently accessed by the one or more client devices). In some conventional systems, the platform can provide media item access history data as input to an artificial intelligence (AI) model that is trained to generate an embedding based on given media item access history data and to predict media items (e.g., of the media item corpus) that are of interest to the user based on the generated embedding.

In conventional systems, an updated media item access history embedding (also referred to simply as “embedding” herein) is generated for each request for media item access. For example, the platform can receive a request for media item access from a client device associated with a user. Upon receiving the request, the platform generates an embedding based on a set of media items previously accessed by one or more client devices associated with the user and feeds the generated embedding as input to an Al model. The platform can identify a media item of interest to the user based on one or more outputs of the AI model and the platform can provide the requesting client device with access to the identified media item (e.g., for presentation to the user). The platform can update the set of previously accessed media items to include the identified media item and, in some instances, can obtain user engagement data based on a user engagement with the media item (e.g., during or after the presentation). The platform can receive an additional request from the client device to access additional media items (e.g., immediately after accessing the media item). Upon receiving the additional request, the platform regenerates the embedding based on the updated set of previously accessed media items and the obtained user engagement data and feeds the updated embedding to the AI model. As indicated above, the platform can continuously update the set of previously accessed media items to include each media item provided for presentation to the user and, accordingly, can continuously update the embedding based on the continuously updated set of previously accessed media items.

As indicated above, each media item access history embedding is generated based on a significantly large amount of media item access history data (e.g., data for hundreds or thousands of media items most recently accessed by one or more client devices of a user). Generating each updated embedding based on the large amount of media item access history data consumes a large amount of computing resources (e.g., processing cycles, memory space) of the overall system. Media items provided for access by a platform more frequently include short-form media items (e.g., as opposed to long-form media items). Short-form media items are of a shorter duration (e.g., less than 120 seconds, less than 60 seconds, etc.) and include visually or audibly rich content for all or most of the media item duration. Long-form media items are of a longer duration (e.g., ranging from several minutes to several hours), which allows for a lower concentration of visually or audibly rich content for the media item duration. Due to the shorter duration of short-form media items, a platform receives a larger number of media item access requests from a client device accessing short-form media items in a given time period than a client device accessing long-form media items in the given time period. In such time period, the platform is therefore updating the media item access history embedding more frequently for the client device accessing the short-form media items than for the client device accessing the long-form media items. Since generating each updated embedding consumes a large amount of computing resources, updating the embeddings for each short-form media item access request in the given time period consumes a significantly large amount of computing resources, which makes such computing resources unavailable to other processes in the system. Accordingly, an overall efficiency and/or an overall throughput of the system is decreased and an overall latency of the system is increased.

Further, a user's interest in particular types or categories of media items may not change during a given time period when the client device of the user is requesting access to short-form media items. Therefore, updating the embedding to reflect the media items and/or user engagement during the given time period may not enable the AI model to make more accurate predictions of media items that are of interest to the user. As the updated embeddings in the conventional system do not enable the AI model to make more accurate predictions of media items of interest, the computing resources consumed to update the embeddings are wasted, which further reduces the overall efficiency and further increases the overall latency of the system.

Aspects of the present disclosure address the above and other deficiencies by providing asynchronous updates for media item access history embeddings. A platform (e.g., a content-sharing platform) can identify a media item access history embedding associated with a client device associated with a user. The media item access history embedding (also referred to simply as an “embedding” herein) may have been previously generated by the platform based on a first set of media items previously accessed by one or more client devices associated with the user. In some embodiments, the platform generates the embedding by providing media access history data indicating characteristics and/or features associated with each of the first set of media items and/or user engagement data for each of the set of media items (e.g., a duration of time that the user accessed each media item, whether the user endorsed (e.g., “liked”) or did not endorse (e.g., “disliked”) the media item, etc.) as input to an artificial intelligence (AI) model that is trained to generate or otherwise predict embeddings based on given media access history data. Such model is referred to as an embedding model herein. The platform can determine the embedding representing the media item access history associated with the first set of media items based on one or more outputs of the AI model and can store the embedding at a region of memory associated with the platform. In some embodiments, the platform can identify the media item access history from the region of memory. In some embodiments, the platform identifies the embedding without receiving a request for media item access from a client device associated with the user (e.g., the embedding is identified asynchronously).

The platform can determine whether one or more embedding relevance criteria are satisfied with respect to the media item access history of the client device and can either provide a client device with access to media items based on the identified embedding or generate an updated embedding associated with the client device based on the determination. In some embodiments, the platform can determine whether the embedding relevance criteria are satisfied by determining whether a difference between prior media item engagement data associated with the client device and current media item engagement data associated with the client device falls below a threshold difference. In additional or alternative embodiments, the platform can determine whether the embedding relevance criteria are satisfied by determining whether a current time period corresponds to an expected media item access time period for the client device based on the media item access history of the client device. In yet additional or alternative embodiments, the platform can determine whether the embedding relevance criteria are satisfied by determining whether a number of the first set of media items accessed by the client device during a prior time period falls below a threshold number of media items. In yet additional or alternative embodiments, the platform can determine whether the embedding relevance criteria are satisfied by determining whether a number of requests from the client device indicating an update to an embedding associated with the client device falls below a threshold number. In yet additional or alternative embodiments, the platform can determine whether the embedding relevance criteria are satisfied by determining whether metadata for the embedding indicates that the identified embedding is invalid. Further details regarding the embedding relevance criteria are provided herein.

Upon determining that the embedding relevance criteria are satisfied, the platform can determine that the identified embedding reflects a current interest of the user and, therefore, an updated embedding is not to be generated. Accordingly, the platform can identify a media item of interest to the user based on the identified embedding by providing the identified embedding as input to an Al model that is trained to predict media items of interest to a user based on a given media item access history embedding. The AI model can predict media items of interest to a user by predicting engagement data (e.g., whether the user will access the media item for the entire duration of the media item, whether the user will endorse the media item, whether the user will not endorse the media item, etc.) for one or more media items not yet accessed by the user, in some embodiments. Such model is referred to as a media item model herein. The platform can obtain one or more outputs of the media item model, which can indicate one or more media items not yet accessed by ne or more client devices associated with the user and, for each media item, predicted engagement data indicating a user interaction with and/or a user reaction to the respective media item. In some embodiments, the one or more outputs of the media item model can include a ranked list of media items not yet accessed by a client device of the user, where each media item is ranked based on the predicted engagement data. The platform can identify a media item of interest to the user based on the one or more outputs of the media item model. For example, the platform can identify a media item of interest to the user by identifying a media item of the one or more outputs having predicted engagement data that satisfies one or more criteria (e.g., indicates that the user is likely to access the media item for the entire duration of the media item, a level of confidence that the user will like the media item exceeds a confidence threshold, etc.). In other or similar embodiments, the platform can identify a media item of interest to the user by identifying the highest ranked media item from the ranked list indicated by the one or more outputs. The platform can provide a client device of the user with access to the identified media item (e.g., in response to a media item access request from the client device).

Upon determining that the embedding relevance criteria are not satisfied, the platform can determine that the identified embedding does not reflect the current interest of the user and therefore, an updated embedding is to be generated. In such embodiments, the platform can identify media item access history data associated with a set of most recently accessed media items by a client device associated with the user. In some embodiments, the set of most recently accessed media items can include one or more media items for which the identified embedding was generated. The platform can provide the media item access history data as input to the embedding model and can obtain the generated embedding based on one or more outputs of the embedding model. Upon obtaining the generated embedding, the platform can provide the generated embedding as input to the media item model and can identify the media item of interest to the user based on one or more outputs of the model, as described above.

Aspects of the present disclosure cover techniques to improve operations of a platform providing users with access to media items by performing media item access history embedding updates asynchronously instead of upon each media item access request. As indicated above, embodiments of the present disclosure enable a platform to generate an embedding based on the most recent media item access history when one or more embedding relevance criteria are satisfied. The embedding relevance criteria trigger embedding updates by the platform based on a determination that a user is engaging differently with respect to recent media items than they were to previous media items, a time period at which the embedding relevance criteria are considered by the platform is outside of an expected media item access time period for one or more client devices of the user, the one or more client devices have accessed a threshold number of media items since the last embedding update, the number of requests to update the embedding exceeds a threshold, the user has requested to erase their media item access history at the platform (e.g., making the previously generated embedding invalid), etc. So long as the embedding relevance criteria are satisfied, the platform can use a previously generated embedding to identify media items of interest to the user. Therefore, the platform generates updated embeddings less frequently than upon each request for media item access by a client device, which significantly reduces the amount of computing resources consumed by the overall system. As fewer computing resources are consumed by the overall system, more computing resources are made available to other processes of the system, which increases an overall efficiency and throughput and decreases an overall latency of the system. In addition, as the platform generates the updated embeddings less frequently, data for a larger set of previously watched media items can be used to generate such embeddings without impact to the efficiency of or latency of the overall system. Accordingly, the generated embeddings can more accurately reflect the current user interest and/or user interest history, which can enable the media item model to make more accurate predictions.

Further, embodiments of the present disclosure enable a platform to generate the embeddings using an AI model (e.g., the embedding model) that is separate or distinct from the AI model that predicts media items of interest to the user (e.g., the media item model). Such models can be trained separately, which can significantly reduce the amount of computing resources consumed to train the media item model.

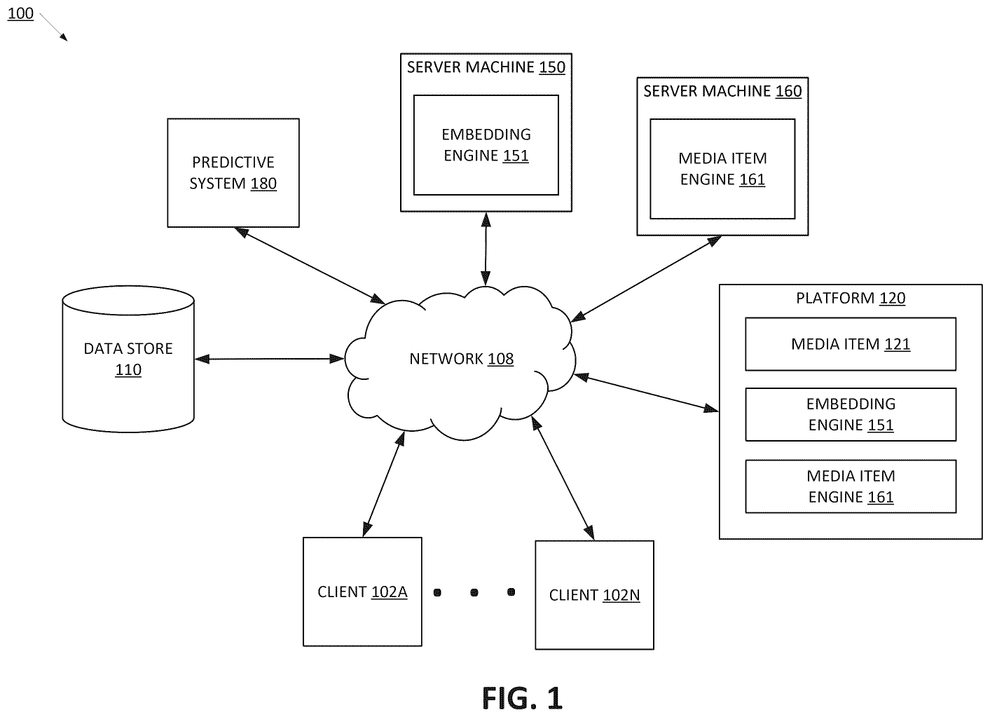

FIG. 1 illustrates an example system architecture 100, in accordance with implementations of the present disclosure. The system architecture 100 (also referred to as “system” herein) includes client devices 102A-N, a data store 110, a platform 120, a server machine 150 and/or a server machine 160 each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more media items 121 accessible to a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108. In some embodiments, data store 110 can store or can otherwise reference one or more media items 121. In additional or alternative embodiments, data store 110 can store data indicating a media item access history associated with client devices of one or more users of platform 120. Such data can be or can otherwise include a media item access history embedding, as described herein.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. In some embodiments, a user can request access to a particular media item 121. In other or similar embodiments, a user can request access to one or more media items 121 (e.g., without specifying a particular media item 121). The platform 120 can identify one or more media items of interest to the user in response to such request, as described herein. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

As described above, platform 120 can provide users with access to media items 121 (e.g., of a media item corpus of, connected to, or otherwise associated with data store 110). In some embodiments, platform 120 can generate and/or maintain media item access history data that indicates one or more media items 121 previously accessed by one or more client devices 102 associated with a user and engagement data indicating an interaction or a reaction of the user with the previously accessed media items 121. Engagement data can include data or information that indicates, for a given media item 121 previously accessed by the user, a duration of time that the user accessed the media item 121, whether the user terminated or ended access to the media item 121 before accessing the end of the media item 121 (e.g., whether the user “skipped” the media item 121), user reaction data (e.g., whether the user endorsed (“liked”) or did not endorse (“disliked”) the media item, etc.) and/or user interaction data (e.g., whether the user requested to send the media item 121 to a client device 102 associated with another user (“shared”), whether the user requested to save the media item 121 in a region of memory of platform 120 for future access (“saved”), etc.). In some embodiments, platform 120 can maintain media item access history data for a particular number of media items 121 previously accessed by a user. For example, platform 120 can maintain media item access history data for hundreds or thousands of media items 121 previously accessed by the user. In other or similar embodiments, platform 120 can maintain media item access history data for media items 121 accessed by the user within a particular time period. For example, platform 120 can maintain access history data for media items 121 accessed by the user during a most recent 24 hour time period, 48 hour time period, etc.

For purposes of example and illustration, media item access history data may be described as including an indication for a set of media items previously accessed by a user (or by one or more client devices 102 associated with a user) and engagement data associated with each of the set of media items. It should be noted, however, that media item access history data can include any type of data or information pertaining to a media item 121 previously accessed by a user, or a client device 102 associated with the user. Further, although embodiments may provide that media items 121 were previously accessed by a client device 102 associated with the user, such embodiments can be applied to any device associated with the user to access the media item 121. For example, a first media item 121 may be accessed via a first client device 102A associated with the user, while a second media item 121 may be accessed via a second client device 102B associated with the user. Such first media item 121 and second media item 121 can be included or otherwise associated with media item access history pertaining to the user, the first client device 102A and/or the second client device 102B.

In some embodiments, platform 120 can generate and/or otherwise maintain an embedding that represents the media item access history of the user. An embedding refers to a low-dimensional representation of high-dimension data. In some embodiments, the embedding generated and/or maintained by platform 120 can include a low-dimensional, continuous vector representation of variables that can be translated to high-dimensional vectors that represent or otherwise include detail pertaining to the media item watch history of the user. Platform 120 can use the embedding to identify media items of interest to a user, as described herein. Such embeddings generated and/or maintained by platform 120 are referred to herein as “media item access history embeddings” or simply “embeddings.” It should be noted that although some embodiments of the present disclosure refer to an embedding as a low-dimensional, continuous vector representation, such embodiments can be applied to any type of representation of the media item access history data. Further, embodiments of the present disclosure can be applied to any type of data or information that represents a media item access history of a user and/or a client device 102 (e.g., other than embeddings).

As illustrated in FIG. 1, platform 120 can include an embedding engine 151 and/or a media item engine 161. In other or similar embodiments, embedding engine 151 can reside at a server machine 150 that is connected to or otherwise remote from platform 120 (e.g., via network 108). In additional or alternative embodiments, media item engine 161 can reside at a server machine 160 that is connected to or otherwise remote from platform 120. Embedding engine 151 can generate an embedding based on media item access history data associated with a user and/or a client device 102 associated with the user. In some embodiments, embedding engine 151 can generate the embedding by feeding media item access history data to an artificial intelligence (AI) model (e.g., embedding model 260) that is trained to predict or otherwise generate an embedding that represents a media item access history of a client device 102 based on given media item access history data. It should be noted that although some embodiments of the present disclosure provide that the embedding engine 151 generates the embedding by applying embedding model 260 to media item access history data, embedding engine 151 can generate the embedding according to any technique for generating an embedding. In some embodiments, platform 120 can request that embedding engine 151 generate and/or update an embedding upon determining that one or more embedding relevance criteria are satisfied, as described herein.

Media item engine 161 of platform 120 can identify one or more media items 121 of interest to a user based on a media item access history associated with the user and/or a client device 102 associated with the user. In some embodiments, platform 120 can identify an embedding previously generated for a user at a region of memory associated with platform 120 and/or client device 102. Platform 120 can determine whether one or more embedding relevance criteria are satisfied with respect to the media item access history of the client device 102, as described herein. Upon determining that the one or more embedding relevance criteria are satisfied (e.g., indicating that the embedding is up to date according to the update scheme associated with platform 120), platform 120 can copy the embedding from the region of memory and provide the copied embedding to media item engine 161. Upon determining that the one or more embedding relevance criteria are not satisfied (e.g., indicating that the embedding is not up to date according to the update scheme), embedding engine 151 can generate an updated embedding based on media item access history data pertaining to a set of media items most recently accessed by the user, as described herein. Platform 120 can provide the generated embedding to media item engine 161, as described above.

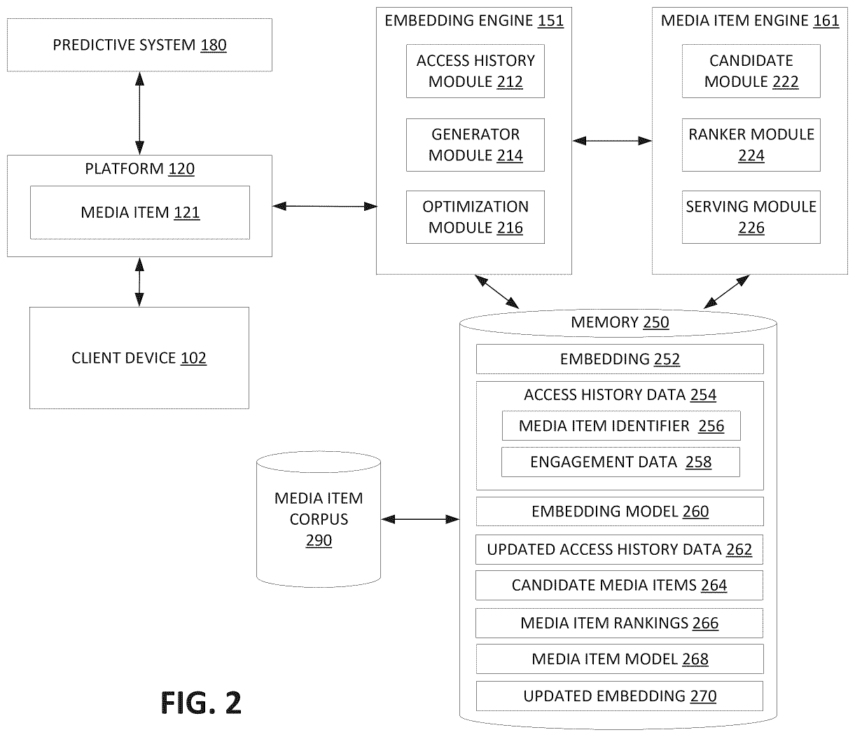

Media item engine 161 can provide an embedding (e.g., copied from data store 110 and/or generated by embedding engine 151) as input to an AI model (e.g., media item model 268) that is trained to predict, based on a given embedding) one or more media items of interest to a user based on media item access history of the user and/or a client device 102 associated with the user. Media item 161 can identify a media item of interest to the user based on one or more outputs of the model and can provide a user with access to the media item via client device 102, as described above. Further details regarding embedding engine 151 and media item engine 161 are described below with respect to FIG. 2.

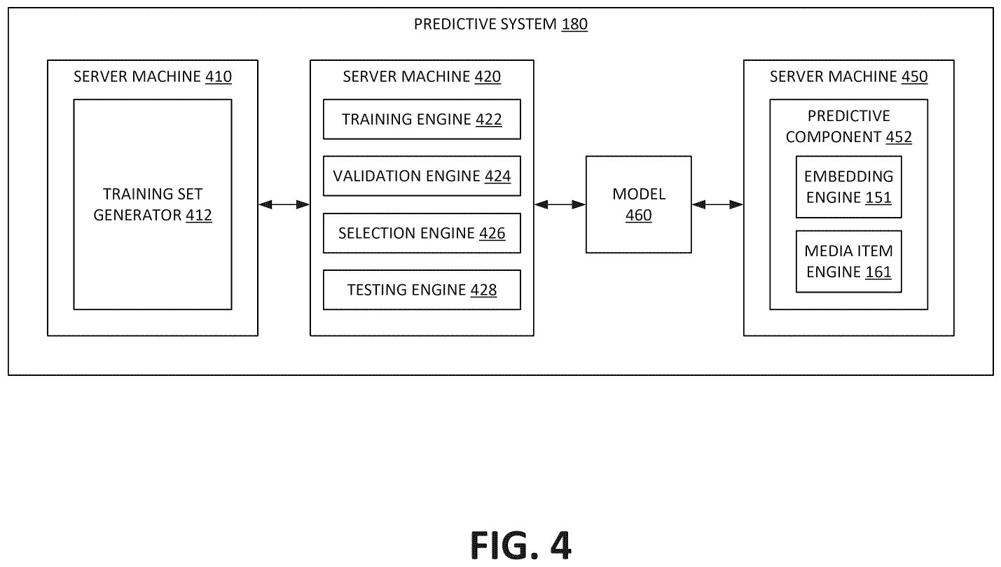

As described above, in some embodiments, embedding engine 151 can generate an embedding based on one or more outputs of an embedding model 260. In additional or alternative embodiments, media item engine 161 can identify a media item of interest to a user based on one or more outputs of a media item model 268. In some embodiments, embedding model 260 and/or media item model 268 can be trained by one or more components of predictive system 180. In additional or alternative embodiments, embedding engine 151 and/or media item engine 161 can include, be included in, or otherwise correspond to a predictive component of predictive system 180 (e.g., predictive component 452). Such predictive component can feed data as input to embedding model 260 and/or media item model 268, in accordance with embodiments described herein. Further details regarding predictive system 180 are described with respect to FIG. 4.

It should be noted that although FIG. 1 illustrates embedding engine 151 and media item engine 161 as part of platform 120, in additional or alternative embodiments, embedding engine 151 and media item engine 161 can reside on one or more server machines that are remote from platform 120 (e.g., server machine 150, server machine 160). It should be noted that in some other implementations, the functions of server machines 150, 160 and/or platform 120 can be provided by a fewer number of machines. For example, in some implementations, components and/or modules of any of server machines 150, 160 may be integrated into a single machine, while in other implementations components and/or modules of any of server machines 150, 160 may be integrated into multiple machines. In addition, in some implementations, components and/or modules of any of server machines 150, 160 may be integrated into platform 120.

In general, functions described in implementations as being performed by platform 120 and/or any of server machines 150, 160 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

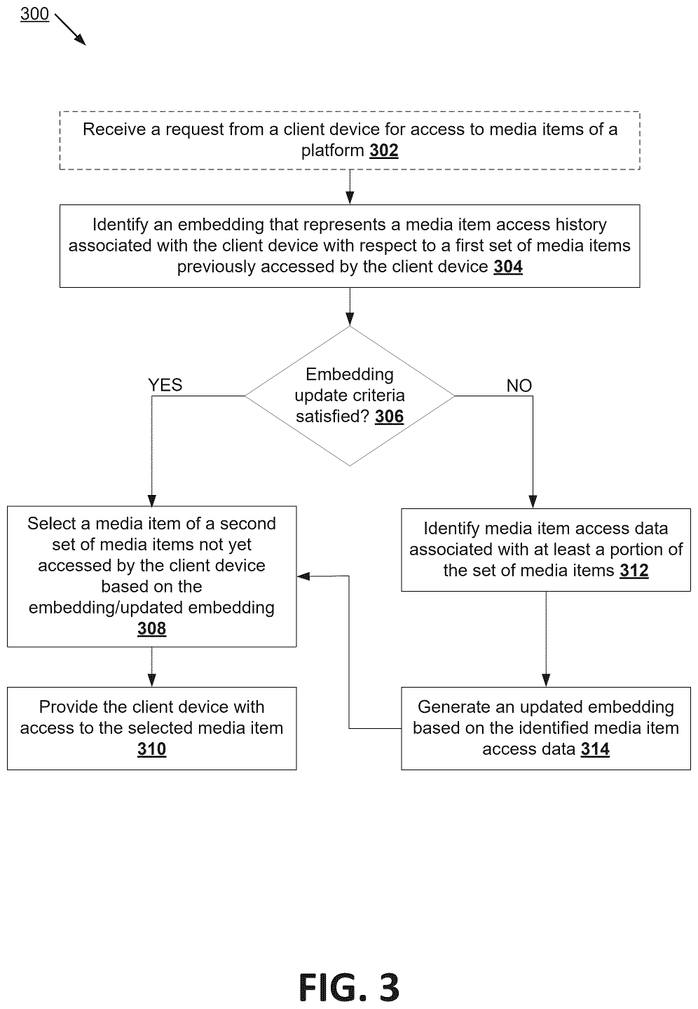

FIG. 2 is a block diagram including an example embedding engine 151 and an example media item engine 161, in accordance with implementations of the present disclosure. As described above, platform 120 can provide users (e.g., of client devices 102) with access to media items 121. In some embodiments, platform 120 can identify media items 121 of interest to a user (e.g., upon receiving a request for access to media items 121) based on an embedding representing a media item access history of the user and/or client device 102. Embedding engine 151 can generate the embedding, as described herein. Media item engine 161 can identify the media item of interest to the user based on the embedding. As illustrated in FIG. 2, embedding engine 151 can include an access history module 212, a generator module 214, and/or an optimization module 216. As also illustrated in FIG. 2, media engine 161 can include a candidate module 212, a ranker module 214, and/or a serving module 216. Details regarding embedding engine 151 and media item engine 161 are provided with respect to FIGS. 2 and 3.

In some embodiments, platform 120, embedding engine 151, media item engine 161, and/or predictive system 180 can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100.

FIG. 3 depicts a flow diagram of an example method 300, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by platform 120, embedding engine 151, and/or media item engine 161 as described above.

At block 302, processing logic optionally receives a request from a client device for access to media items of a platform. As described above, a user of client device 102 can request access to one or more media items 121 of platform 120. In some embodiments, platform 120 can provide client device 102 with a UI that can present one or more media items 121 to a user of client device 102. The user can request access to the one or more media items 121 by engaging with one or more elements of the UI. For example, the user can engage with one or more search elements of the UI to provide a title or other characteristics associated with a particular media item 121 of interest to the user. Upon detecting the user engagement with the one or more search elements, client device 102 can transmit the provided title or other characteristics to platform 120 (e.g., via network 108). In other or similar embodiments, client device 102 can request access to the media items without any user interaction with the UI. For example, upon detecting that the user has requested access to the UI (e.g., by engaging with an application UI element associated with platform 120 presented by client device 102), client device 102 can forward a request to platform 120 (e.g., without detecting user engagement of any UI elements of the platform UI).

At block 304, processing logic identifies an embedding that represents a media item access history associated with the client device with respect to a first set of media items previously accessed by the client device. Platform 120 may identify an embedding previously generated by embedding engine 151, as described herein.

Referring back to FIG. 2, embedding engine 151 can generate an embedding 252 that represents a media item access history associated with a client device 102 and/or a user of client device 102. Embedding engine 151 can generate the embedding 252 based on access history data 254 for a set of media items 121 previously accessed by client device 102. In some embodiments, the set of media items 121 can include a particular group of media items 121 of an overall media item access history associated with the client device 102. For example, the set of media items 121 can include a particular number (e.g., hundreds, thousands, etc.) of media items most recently accessed by the client device 102. Other media items that were less recently accessed by the client device 102 may not be included in the set of media items 121. In another example, the set of media items 121 can include media items that were accessed within a particular time period, such as within the past day or past week from when the embedding 252 is to be generated. Criteria pertaining to the group of media items 121 that are to be included in the set of media items 121 used to generate the embedding 252 can be defined or otherwise provided by a developer or administrator associated with platform 120, in some embodiments. In other or similar embodiments, the criteria pertaining to the group of media items 121 that are to be include in the set of media items 121 can be determined based on experimental or historical data associated with platform 120. For example, platform 120 can determine, based on experimental or historical data associated with media items 121 accessed by users of platform 120, that embeddings 252 generated based on a set of media items 121 satisfying a particular criteria (e.g., having a particular number of media items 121, having media items 121 accessed within a particular time period, etc.) can enable media item model 268 to predict media items 121 of interest to a user more accurately. Accordingly, such criteria can be applied to determine the media items 121 of a media item access history that are to be included in the set of media items 121 used to generate embedding 252.

Access history module 212 of embedding engine 151 can obtain access history data 254 associated with a set of media items 121 to be used to generate embedding 252. In some embodiments, access history module 212 can identify the media items 121 that are to be included in the set based on the criteria pertaining to the group of media items 121 previously accessed by the user, as described above. In an illustrative example, access history module 212 can determine criteria to be used to identify the set of media items 121 (e.g., based on a setting or parameter associated with platform 120). For purposes of example and illustration only, the criteria can provide that the 1000 most recently access media items by the client device 102 are to be included in the set of media items. Access history module 212 can identify each media item 121 of a media item corpus 290 that satisfies the determined criteria. Media item corpus 290 can include each media item 121 accessible to users of platform 120. In some embodiments, media item corpus 290 can be included with or otherwise connected to memory 250.

Upon determining the media items 121 of media item corpus 290 that satisfy the criteria, access history module 212 can obtain access history data 254 pertaining to each determined media item 121. As illustrated in FIG. 2, access history data 254 can include an identifier 256 for each media item 121 of the set of media items 121 and/or engagement data 258 associated with each media item 121. Engagement data 258 can include data or information that indicates, for a given media item 121 previously accessed by the user, a duration of time that the user accessed the media item 121, whether the user terminated or ended access to the media item 121 before accessing the end of the media item 121 (e.g., whether the user “skipped” the media item 121), user reaction data (e.g., whether the user endorsed (“liked”) or did not endorse (“disliked”) the media item, etc.) and/or user interaction data (e.g., whether the user requested to send the media item 121 to a client device 102 associated with another user (“shared”), whether the user requested to save the media item 121 in a region of memory of platform 120 for future access (“saved”), etc.), and so forth. In some embodiments, platform 120 can obtain such engagement data 258 during or after presentation of a media item 121 to a user and can store such data 258 at memory 250. Access history module 212 can identify the engagement data 258 of memory 250 that corresponds to the set of media items 121.

Generator module 214 of embedding engine 151 can generate an embedding 252 that represents the media item access history of client device 102 based on access history data 254. In some embodiments, generator module 214 can provide access history data 254 as input to embedding model 260, which can be an Al model that is trained to predict an embedding that represents the media item access history of a client device 102 based on given access history data 254. Upon providing access history data 254 as input to embedding model 260, generator module 214 can obtain one or more outputs of embedding model 260. The one or more outputs can include one or more embeddings and, for each embedding, a level of confidence that a respective embedding represents the media item access history of client device 102 based on the media item access history indicated by access history data 254. Generator module 214 can identify, of the one or more outputs, the embedding having a level of confidence that satisfies one or more confidence criteria (e.g., exceeds a threshold level of confidence, is larger than levels of confidence for other embeddings of the outputs, etc.). Such identified embedding can be determined as the embedding 252 that represents the media item access history of client device 102. It should be noted that other techniques can be applied to generate or otherwise obtain embedding 252. For example, the outputs of embedding model 260 may include a single embedding. Such embedding can be identified as the embedding 252 representing the media item access history of client device 102. In another example, generator module 214 can feed access history data 254 as input to an embedding generator function (e.g., that does not implement AI or machine learning techniques) and can obtain one or more outputs of the embedding generator function that include embedding 252. Any embedding generation technique can be used, according to embodiments of the present disclosure, to generate or otherwise obtain embedding 252.

Upon generating embedding 252, embedding engine 151 can provide the generated embedding 252 to platform 120. In additional or alternative embodiments, platform 120 can store the embedding 252 at a region of memory 250 associated with client device 102 and/or the user. In some embodiments, memory 250 can include an embedding data structure (not shown) that includes one or entries that store a mapping between an identifier associated with client device 102 and an embedding 252 generated based on the media item access history of the client device 102. In other or similar embodiments, the mapping can be between the identifier for the client device 102 and a memory address indicating a region of memory 250 (or another memory) that stores embedding 252. In some embodiments, platform 120 can update one or more entries of the embedding data structure to include a mapping between the identifier associated with client device 102 and the generated embedding 252. In an illustrative example, platform 120 can determine whether one or more entries of the embedding data structure includes a mapping between the identifier for client device 102 and a previously generated embedding 252. Upon determining that no entries of the embedding data structure includes the mapping, platform 120 can update the embedding data structure to include the mapping between the client device 102 identifier and the embedding 252 (or the region of memory 250 that stores the embedding 252). Upon determining that one or more entries of the embedding data structure include the mapping, platform 120 can update such entries to remove the mapping to the previously generated embedding and include the mapping between the client device 102 identifier and the newly generated embedding 252.

As described in further detail herein, platform 120 can use the embedding 252 to identify one or more media items 121 of interest to the user and can provide the user with access to such media items 121. In some embodiments, platform 120 can update access history data 254 to include the identifiers 256 associated with the media items 121 identified based on the embedding 252 and/or engagement data 258 associated with the media items 121. For example, while or after such media items 121 are provided for presentation to the user, platform 120 can obtain engagement data 258 from client device 102, as described above. Upon obtaining the engagement data 258, platform 120 can store the obtained engagement data 258 and an identifier associated with such media items 121 at memory 250 as updated access history data 262. Since updated access history data 262 is obtained after embedding 252 is generated, embedding 252 does not reflect the user's current interest, at least according to updated access history data 262.

Referring back to FIG. 3, as indicated above, processing logic (e.g., platform 120) can identify an embedding 252 that represents the media item access history associated with client device 102. In some embodiments, platform 120 can parse the embedding data structure to determine whether one or more entries include a mapping between an identifier of client device 102 and an embedding 252 (or a region of memory 250 that stores the embedding 252). Upon identifying the entry that includes the mapping, platform 120 can extract the embedding 252 from the entry and/or can copy the embedding 252 from the region of memory 250 that includes the embedding 252.

As indicated above, platform 120 can identify the embedding 252 responsive to receiving the request from client device 102 (e.g., per block 302), in some embodiments. In other or similar embodiments, platform 120 can identify the embedding 252 without receiving a request from client device 102. For example, platform 120 can identify the embedding 252 according to an embedding update protocol defined by a developer or administrator of platform 120. In another example, platform 120 can receive or otherwise detect an instruction to identify the embedding 252 from a component of platform 120 and/or from another component or engine of system 100 (or outside of system 100).

At block 306, processing logic determines whether one or more embedding relevance criteria are satisfied with respect to the media item access history of the client device. In some embodiments, the embedding relevance criteria can by identified or otherwise defined to trigger embedding updates based on a determination that a user is engaging differently with respect to recent media items 121 than they were to previous media items 121, that a time period at which the embedding relevance criteria are considered by the platform 120 is outside of an expected media item access time period for one or more client devices 102 of the user, that the one or more client devices 102 have accessed a threshold number of media items since the last embedding update, that the number of requests to update the embedding exceeds a threshold, that the user has requested to erase their media item access history at the platform 120 (e.g., making the previously generated embedding invalid), and so forth. If the embedding relevance criteria are satisfied (as described below), this can indicate to platform 120 that the previously generated embedding 252 for client device 102 is still relevant to the current user interest for media items 121 of platform 120. If the embedding relevance criteria are not satisfied (as described below), this can indicate to platform 120 that the previously generated embedding 252 for client device 102 is no longer relevant to the current user interest for media items 121 of platform 120 and that an updated embedding 252 should be generated based on updated access history data 262 and/or access history data 254.

In some embodiments, access history module 212 (or another module or component of embedding engine 151 or of platform 120) can determine whether the one or more embedding relevance criteria are satisfied by determining whether a difference between prior media item engagement data 258 (e.g., of access history data 254) and current media item engagement data 258 (e.g., of updated access history data 262) falls below a threshold difference. If the difference falls below the threshold difference, this can indicate that the user is engaging with (e.g., “liking,” “disliking,” etc.) media items 121 that are recommended based on the previously generated embedding 252 in the same or similar manner as the engagement with the previously access media items for which the embedding 252 was generated (e.g., of access history data 254), which can indicate that the previously generated embedding 252 is still relevant to the user's interest. Accordingly if the difference falls below the threshold difference, access history module 212 can determine that the one or more criteria are satisfied and therefore media item engine 161 can continue to predict media items 121 of interest to the user based on the previously generated embedding 252. If, however, the difference exceeds the threshold difference, this can indicate that the user is engaging with the media items 121 recommended based on the previously generated embedding 252 in a different manner than the engagement with the previously accessed media items, which can indicate that the previously generated embedding 252 is no longer relevant to the user's interest. Accordingly, if the difference exceeds the threshold difference, access history module 212 can determine that the one or more criteria are not satisfied and therefore an updated embedding 252 is to be generated.

In one or more embodiments, access history module 212 can determine whether the difference between the prior media item engagement data 258 and the current media item engagement data 258 falls below the threshold difference based on endorsement metrics (e.g., indicating a number of “likes” by the user) and/or disapproval metrics (e.g., indicating a number of “dislikes” by the user) of the engagement data 258. In some embodiments, a user can “like” or “dislike” a media item 121 by engaging with one or more designated UI elements of the UI of platform 120. In an illustrative example, access history module 212 can extract a prior endorsement metric and/or a prior disapproval metric from the prior media item engagement data 258. The prior endorsement metric can indicate a number of a first set of media items “liked” by the user, where the first set of media items include media items for which the embedding 252 was generated. The prior disapproval metric can indicate a number of the first set of media items “disliked” by the user. Access history module 212 can also extract a current endorsement metric and/or a current disapproval metric from the current media item engagement data 258. The current endorsement metric can indicate a number of a second set of media items “liked” by the user, where the second set of media items include media items accessed by the user between a current time period and a time period after the embedding 252 was generated. The current disapproval metric can indicate a number of the second set of media items “disliked” by the user. Access history module 212 can determine whether the difference between the prior media item engagement data and the current media item engagement data falls below the threshold difference by determining whether the difference between the current endorsement metric and the prior endorsement metric falls below the threshold difference and/or the difference between the current disapproval metric and the prior disapproval metric falls below the threshold difference, in some embodiments.

In other or similar embodiments, access history module 212 can determine whether the one or more embedding relevance criteria are satisfied by determining whether a current time period (e.g., a time of day at which platform 120 has identified the previously generated embedding 252) corresponds to an expected media item access time period (e.g., time of day) for the client device based 102 on the media item access history of the client device 102. In some embodiments, engagement data 258 (or other data stored at memory 250 or otherwise associated with platform 120) can include a timestamp or other type of indication of the time of day that a client device 102 requests access to a media item 121. Access history module 212 (or another module or component of embedding engine 151) can determine a time period during which the user typically requests media items 121 from platform 120 based on such timestamps for media items 121 previously accessed by the client device 102. For example, access history module 212 can identify time period that a client device 102 requests access to media items 121 based on a range of timestamps associated with such requests. In some embodiments, access history module 212 can track or otherwise update the time period based on timestamps of requests received over a threshold amount of time (e.g., multiple days, weeks, etc.). In some embodiments, the indication of the determined time period can be stored at memory 250 as an expected media item access time period (not shown).

In some embodiments, access history module 212 can determine the expected media item access time period (e.g., from memory 250) and can determine whether the time of day at which platform 120 has identified the previously generated embedding 252 (e.g., the current time period) corresponds to the expected media item access time period. The current time period can correspond to the expected media item access time period if the current time period falls within the range of timestamps that define the expected media item access time period, in some embodiments. In other or similar embodiments, the current time period can correspond to the expected media item access time period if a distance between the current time period and one or more timestamps of the range of timestamps that define the expected media item access time period falls below a threshold distance (e.g., indicating that the current time period is adjacent to or approximately adjacent to the timestamps of the expected media item access time period. A determination that the current time period corresponds to the expected media item access time period can indicate that the client device 102 may (or is likely to) request access to additional media items 121 and therefore the embedding 252 should not be updated until the expected media item access time period has passed (e.g., indicating an end of a user daily access session), in some embodiments. In such embodiments, access history module 212 can determine that the one or more criteria are satisfied. In other or similar embodiments, a determination that the current time period does not correspond to the expected media item access time period can indicate that the client device 102 may not (or is unlikely to) request access to additional media items 121 (e.g., indicating the end of the user daily access session) and therefore the embedding 252 should be updated. In such embodiments, access history module 212 can determine that the one or more criteria are not satisfied.

In yet other or similar embodiments, access history module 212 can determine whether the one or more embedding relevance criteria are satisfied by determining whether a number of media items accessed by the client device after generation of the embedding 252 falls below a threshold number of media items. As described herein, platform 120 can identify media items 121 of interest to a user based on embedding 252 and can provide the media items 121 for access to the user (e.g., via client device 102). During or after the media items 121 are provided for access to the user, access history module 212 (or another component of platform 120) can update access history data 254 to include a media item identifier 256 for each media item 121, as described above. In some embodiments, access history module 212 can update memory 250 to include a timestamp indicating a time period (e.g., a time of day) during which a respective media item 121 was provided for access to the user. In additional or alternative embodiments, access history module 212 can update memory 250 to include a mapping between the media item identifier 256 and the embedding 252 (e.g., to indicate that the media item 121 was provided for access to the user based on the embedding 252). Access history module 212 can determine the number of media items 121 provided for access to the user based on the embedding based on such timestamps and/or such generated mappings in memory 250. Upon determining the number of media items 121, access history module 212 can determine whether the determined number falls below a threshold number of media items. The threshold number of media items can be defined by a developer or administrator of platform 120, in some embodiments. In other or similar embodiments, the threshold number of media items can be determined based on historical and/or experimental data, in accordance with previously described embodiments.

In some embodiments, the threshold number of media items can be determined for a specific user or client devices 102 associated with the user. In an illustrative example, platform 120 can generate embeddings 252 and identify media items 121 of interest based on the generated embeddings 252, as described herein. Prior to or after generating one or more of the embeddings 252, platform 120 (or another component or engine of system 100) can modify the threshold number of media items of the embedding relevance criteria that trigger generation of an updated embedding 252. Platform 120 can track the prediction accuracy of media item model 268 based on each generated embedding 252, in some embodiments. In some embodiments, optimization module 216 of embedding engine 151 can identify the embedding 252 associated with the highest prediction accuracy of media item model 268 and can determine the value of the threshold number of media items that triggered generation of the identified embedding. In such embodiments, optimization module 216 can update one or more settings or parameters pertaining to the embedding relevance criteria (e.g., for the specific user) to reflect the determined value of the threshold number of media items, in some embodiments. In additional or alternative embodiments, optimization module 216 can update the settings or parameters pertaining to the embedding relevance criteria for one or more additional users (or all users of platform 120) to reflect the determined value of the threshold number of media items.

In yet other or similar embodiments, access history module 212 (or another component of platform 120) can determine whether the one or more embedding relevance criteria are satisfied by determining whether a number of requests to update an embedding 252 associated with the client device 102 falls below a threshold number. In some embodiments, access history module 212 can receive one or more requests to update embedding 252. The requests can be received from client device 102 and/or from another component or module of system 100. In some embodiments, the requests can be scoring requests that are received according to a scoring protocol associated with platform 120. Access history module 212 can track a number of scoring requests received at platform 120 and can determine whether the number of received scoring requests falls below a threshold.

In other or similar embodiments, access history module 212 can determine whether the one or more embedding relevance criteria are satisfied by determining whether metadata for the embedding indicates that the identified embedding is invalid. In some embodiments, a user can request (e.g., via a UI of client device 102) to erase or remove access history data 254 associated with the user from memory 250. Upon receiving the request, client device 102 can forward the request to platform 120. Access history module 212 can erase or otherwise remove the access history data 254 stored at memory 250 for the user and/or client device 102, in response to the request. In some embodiments, access history module 212 can also erase or otherwise remove the embedding 252 generated basted on the (now removed) access history data 254. Upon erasing or removing the embedding 252, access history module 2122 can update metadata for the embedding 252 (e.g., at the embedding data structure, etc.) to indicate that embedding 252 is invalid.

Referring back to FIG. 3, responsive to processing logic determining that the one or more embedding relevance criteria are satisfied, method 300 continues to block 308. In accordance with previously described embodiments, processing logic can determine that the one or more embedding relevance criteria are satisfied by determining that one or more of the difference between the prior media item engagement data for client device 102 and the current media item engagement data for client device 102 falls below a threshold difference, a current time period corresponds to an expected media item access time period for client device 102, a number of media items accessed by client device 102 after generation of embedding 252 falls below a threshold number of media items, a number of requests to update embedding 252 falls below a threshold number, and/or metadata for embedding 252 indicates that embedding 252 is valid.

At block 308, processing logic selects a media item of a set of media items not yet accessed by the client device based on the embedding. Media item engine 161 can identify one or more media items 121 of interest to a user based on embedding 252, in some embodiments. As illustrated in FIG. 2, media item engine 161 can include a candidate module 222, a ranker module 224, and/or a serving module 226. Candidate module 222 can identify one or more candidate media items 264 that are to be fed to media item model 268, in some embodiments. As described above, media item corpus 290 can include a significantly large number (e.g., millions, tens of millions, hundreds of millions, billions) of media items 121. Content of the media items 121 of corpus 290 can have a wide range of topics or categories, in some embodiments. In additional or alternative embodiments, content of media items 121 can be received by platform 120 from a wide range of geographic areas (e.g., all over the world) and therefore can include content in a wide variety of languages. Candidate module 222 can identify a set of candidate media items 264 from media corpus 290 that are expected to be relevant to a user of client device 102 based on access history data 254 and/or other data associated with client device 102. In an illustrative example, data associated with client device 102 can indicate that the user is an English speaker (and does not speak any other languages). Accordingly, the set of candidate media items 264 identified by candidate module 222 can include content that is in English. In another illustrative example, data associated with client device 102 can indicate that the user is interested in (or is interested in) content having a particular type or category. The set of candidate media items 264 can include (or can exclude) media items including content having that particular type or category. It should be noted that candidate module 222 can identify candidate media items 264 according to any candidate media item identification techniques. In some instances, candidate module 222 can identify candidate media items 264 according to one or more AI (or machine learning) techniques.

Ranker module 224 can determine one or more media item rankings for each candidate media item 264 identified by candidate module 222 based on embedding 252 generated based on access history data 254, in some embodiments. In some embodiments, ranker module 224 can provide the set of candidate media items 264 (and/or an identifier associated with each of the set of candidate media items 264) as input to a media item model 268. As described above, media item model 268 can be trained to predict one or more media items of interest to a user of client device 102 based on a given media item access history (represented by embedding 252). Ranker module 224 can also provide embedding 252 as input to media item model 268 (e.g., with candidate media items 264).

In some embodiments, ranker module 224 can obtain one or more outputs of media item model 268. In some embodiments, the one or more outputs can include predicted engagement data for each of the candidate media items 264, in view of the media item access history represented by embedding 252. The predicted engagement data can indicate, in some embodiments, a level of confidence that the user will “like” a respective candidate media item 264, a level of confidence that the user will “dislike” the respective candidate media item 264, a level of confidence that the user will consume the respective candidate media item 264 for the entire duration of the respective candidate media item 264, a level of confidence that the user will “skip” the respective candidate media item 264 before reaching the end of the respective candidate media item 264, and so forth. In some embodiments, the predicted engagement data can be represented or otherwise indicated by a rating or a score that indicates a likelihood that the user will have a positive engagement with the candidate media item 264 (e.g., and therefore is interested in the candidate media item 264), where a high rating or score indicates a high likelihood of positive engagement and a low rating or score indicates a low likelihood of positive engagement (and/or a high likelihood of negative engagement). In additional or alternative embodiments, the one or more outputs can include a ranked set (e.g., a ranked list) of the candidate media items 264 based on the ratings or scores predicted by media item model 268, as described above. The rankings for the candidate media items 264 can be stored at memory 250 as media item rankings 266, in some embodiments.

Serving module 226 can identify one or more of candidate media items 264 to provide to client device 102 based on the one or more outputs of media item model 268. In some embodiments, serving module 226 can identify a candidate media item 264 of the one or more outputs having a level of confidence (e.g., of positive engagement) that satisfies one or more confidence criteria (e.g., meets or exceeds a threshold, is larger than levels of confidence for other candidate media items 264, etc.). Serving module 226 can select such identified candidate media item 264 to be provided to client device 102 for presentation to the user. In other or similar embodiments, serving module 226 can identify a candidate media item 264 having a highest rating or score the ranked set of candidate media items 264 and can select such identified candidate media item 264 to be provided to client device 102, as described above.

Referring back to FIG. 3, at block 310, processing logic provides the client device with access to the selected media item. In some embodiments, serving module 226 can transmit the selected candidate media item 264 (or an identifier associated with the selected candidate media item 264) to client device 102 (e.g., via network 108). Client device 102 can present the selected candidate media item 264 to the user via the UI of platform 120, as described above. In other or similar embodiments, platform 120 can maintain a queue of media items 121 for presentation to the user of client device 102. Serving module 226 can update the queue to include the selected candidate media item 264. Client device 102 can present the media items 121 of the queue to the user (e.g., in accordance with an ordering of media items 121 of the queue). In some embodiments, serving module 226 can identify multiple candidate media items 264 from the one or more outputs of media item model 268 that are of interest to the user. For example, serving module 226 can identify two or more candidate media items 264 of interest to the user based on the media item rankings 266 In such embodiments, serving module 226 can update the queue to include each of the multiple candidate media items 264.

Referring back to block 306 of FIG. 3, responsive to processing logic determining that the one or more embedding relevance criteria are not satisfied, method 300 continues to block 312. In accordance with previously described embodiments, processing logic can determine that the one or more embedding relevance criteria are not satisfied by determining that one or more of the difference between the prior media item engagement data for client device 102 and the current media item engagement data for client device 102 meets or exceeds a threshold difference, a current time period does not correspond to an expected media item access time period for client device 102, a number of media items accessed by client device 102 after generation of embedding 252 meets or exceeds a threshold number of media items, a number of requests to update embedding 252 meets or exceeds a threshold number, and/or metadata for embedding 252 indicates that embedding 252 is invalid.

At block 312, processing logic identifies media item access data associated with a set of media items accessed by the client device since the embedding was generated. The identified media item access data can correspond to updated access history data 262, as described above. At block 314, processing logic generates an updated embedding based on the identified media item access data. Embedding engine 151 can generate an updated embedding 252 based on the updated access history data 262, in accordance with previously described embodiments. For example, access history module 212 can identify updated access history data 262 from memory 250 to be provided to embedding model 260. In some embodiments, access history module 212 can also identify at least a portion of access history data 254 to be provided with updated access history data 262 to embedding model 260 (e.g., according to an embedding generation protocol associated with platform 120). Generator module 214 can geed the identified data 262 and/or data 254 as input to embedding model 260 as described above, and can obtain one or more outputs from embedding model 260. The one or more outputs can include one or more embeddings and, for each embedding, a level of confidence that a respective embedding reflects a media item access history of client device 102 based on updated access history data 262 and/or access history data 254. Generator module 214 can extract updated embedding 270 from the one or more outputs of embedding model 260, as described above.

Upon processing logic generating the updated embedding, method 300 can return to block 308. As described above, at block 308, processing logic selects a media item of a second set of media items not yet accessed by the client device based on the updated embedding 270. In accordance with previously described embodiments, candidate module 222 can identify a set of candidate media items 264 from media item corpus and ranker module 224 can feed the identified set and the updated embedding 270 as input to media item model 268. Serving module 226 can identify one or more candidate media items 268 of interest to the user based on one or more outputs of the media item model 268, in accordance with previously described embodiments. At block 310, processing logic provides the client device with access to the selected media item, as described above. Serving module 226 can provide the client device with access to the selected candidate media item 264, as described above.

FIG. 4 is a block diagram including an example predictive system 180, in accordance with implementations of the present disclosure. In some embodiments, predictive system 180 can be configured to train one or more machine learning models 460 associated with embedding engine 151 and/or media item engine 161. For example, predictive system 180 can be configured to train embedding model 260 and/or media item model 268, described with respect to FIGS. 2-3.

As illustrated in FIG. 4, predictive system 180 can include a training set generator 412 (e.g., residing at server machine 410), a training engine 422, a validation engine 424, a selection engine 426, and/or a testing engine 428 (e.g., each residing at server machine 420), and/or a predictive component 452 (e.g., residing at server machine 450). Training set generator 412 may be capable of generating training data (e.g., a set of training inputs and a set of target outputs) to train model 460.

As mentioned above, training set generator 412 can generate training data for training model 460. Training set generator 412 obtain training data for training model 560 and can organize or otherwise group the training data for training model 460 (e.g., according to the purpose of the model). For example, training set generator 412 can generate training data for training embedding model 260. In some embodiments, training set generator 412, can initializes training set T to null (e.g., { }). Training set generator 412 can obtain historical media item access data for one or more media items previously accessed by a client device 102 connected to platform 120. In some embodiments, training set generator 412 can determine one or more characteristics or patterns of the historical media item access data. In some embodiments, training set generator 412 can obtain an embedding (or other low dimensional representation) of the determined characteristics or patterns. The embedding may be obtained based on an output of an embedding function, or according to other techniques. Training set generator 412 can generate an input/output mapping between the historical media item access data and the embedding, in some embodiments. In some embodiments, the input/output mapping can indicate whether the embedding reflects the characteristics or patterns of the historical media item access data.

Training set generator 412 can add the input/output mapping to training set T and can determine whether training set T is sufficient for training. Training set generator 412 can determine whether training set T is sufficient for training by determining whether a number of input/output mappings of training set T meets or exceeds a threshold number of mappings. Upon determining that training set T is insufficient for training, training set generator 412 can generate additional input/output mappings, as described above. Upon determining that training set T is sufficient for training, training set generator 412 can provide training set T to train the machine learning model 260. In some embodiments, training set generator 412 can provide training set T to training engine 422 to train the machine learning model.

In some embodiments, embedding model 260 can be an autoencoder. In such embodiments, training set generator 412 can generate training data to train embedding model 260 according to autoencoder training techniques.

Training set generator 412 can additionally or alternatively generate training data for training media item model 268, as described above. In some embodiments, the training data for media item model 268 can include an input/output mapping, the input including a media item 121 of media corpus 290 and/or one or more characteristics of the content of media item 121, and the output including an indication of an embedding 252 or other data pertaining to a user that would be interested in the media item 121.

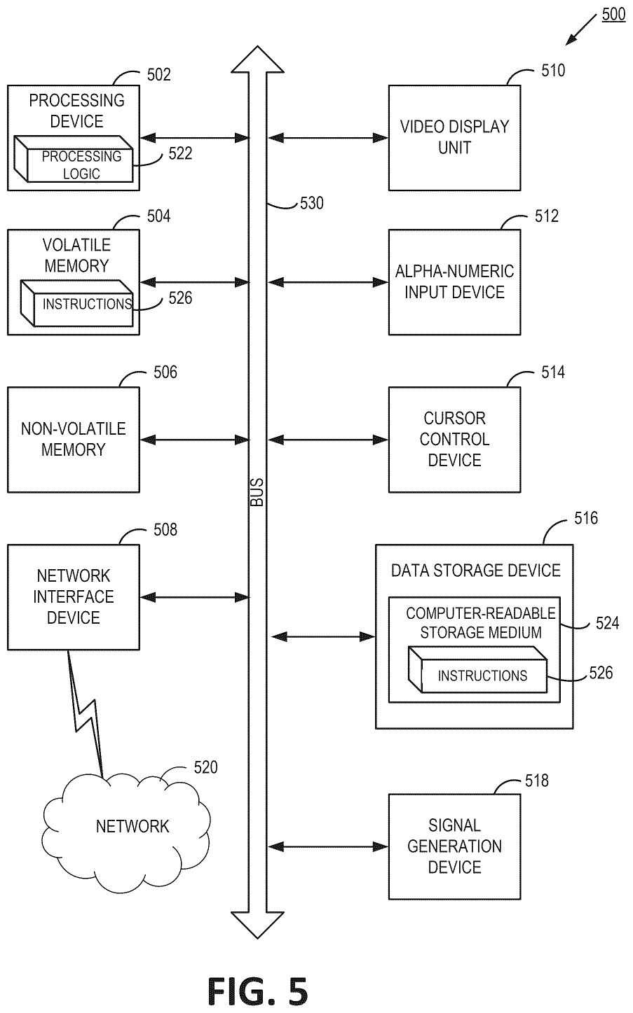

Referring back to FIG. 5, training engine 422 can train a machine learning model 460 using the training data (e.g., training set T) from training set generator 412. The machine learning model 460 can refer to the model artifact that is created by the training engine 422 using the training data that includes training inputs and/or corresponding target outputs (correct answers for respective training inputs). The training engine 422 can find patterns in the training data that map the training input to the target output (the answer to be predicted), and provide the machine learning model 460 that captures these patterns. The machine learning model 460 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. In one aspect, the training set is obtained by training set generator 412 hosted by server machine 410.

Validation engine 424 may be capable of validating a trained machine learning model 460 using a corresponding set of features of a validation set from training set generator 412. The validation engine 424 may determine an accuracy of each of the trained machine learning models 460 based on the corresponding sets of features of the validation set. The validation engine 424 may discard a trained machine learning model 460 that has an accuracy that does not meet a threshold accuracy. In some embodiments, the selection engine 426 may be capable of selecting a trained machine learning model 460 that has an accuracy that meets a threshold accuracy. In some embodiments, the selection engine 426 may be capable of selecting the trained machine learning model 460 that has the highest accuracy of the trained machine learning models 460.

The testing engine 428 may be capable of testing a trained machine learning model 460 using a corresponding set of features of a testing set from training set generator 412. For example, a first trained machine learning model 460 that was trained using a first set of features of the training set may be tested using the first set of features of the testing set. The testing engine 428 may determine a trained machine learning model 460 that has the highest accuracy of all of the trained machine learning models based on the testing sets.

Predictive component 452 of server machine 450 may be configured to feed data as input to model 460 and obtain one or more outputs. As illustrated in FIG. 4, predictive component 452 can include embedding engine 151 and/or media item engine 161. Embedding engine 151 can feed access history data 254 as input to embedding model 260, as described above, and obtain one or more outputs, which can indicate an embedding 252 that represents a media item access history associated with a client device 102. Media item engine 161 can feed candidate media items 264 and/or an embedding 252 as input to media item model 268, as described above, and can obtain one or more outputs indicating a media item 121 of interest to the user.

FIG. 5 is a block diagram illustrating an exemplary computer system 500, in accordance with implementations of the present disclosure. The computer system 500 can correspond to platform 120 and/or client devices 102A-N, described with respect to FIG. 1. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations discussed herein. In some instances, processor 502 is according to execute instructions 526 according to processing logic 522.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 526 embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for providing fine-grained version histories of electronic documents at a platform. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying an embedding that represents a media item access history associated with a client device associated with a user with respect to a first set of media items previously accessed by one or more client devices associated with the user;
determining whether one or more embedding relevance criteria are satisfied with respect to the media item access history of the client device;
responsive to determining that the one or more embedding relevance criteria are satisfied, selecting a media item of a second set of media items not yet accessed by the client device based on the embedding; and
providing the client device with access to the selected media item.

2. The method of claim 1, wherein determining whether the one or more embedding relevance criteria are satisfied with respect to the media item access history of the client device comprises at least one of:
determining whether a difference between prior media item engagement data associated with the client device and current media item engagement data associated with the client device falls below a threshold difference;
determining whether a current time period corresponds to an expected media item access time period for the client device based on the media item access history of the client device;
determining whether a number of media items accessed by the client device after generation of the identified embedding falls below a threshold number of media items;
determining whether a number of requests indicating an update to an embedding associated with the client device falls below a threshold number; or
determining whether metadata for the embedding indicates that the identified embedding is invalid.

3. The method of claim 2, wherein determining whether a difference between prior media item engagement data associated with the client device and current media item engagement data associated with the client device falls below a threshold difference comprises:
extracting, from the prior media item engagement data, one or more of a prior endorsement metric indicating a number of the first set of media items endorsed by the user, or a prior disapproval metric indicating a number of the first set of media items disapproved by the user;
extracting, from the current media item engagement data, one or more of a current endorsement metric indicating a number a third set of media items endorsed by the user, the third set of media items accessed between the current time period and a prior time period during which the embedding was generated, or a current disapproval metric indicating a number of the third set of media items disapproved by the user; and
determining at least one of:
whether a difference between the current endorsement metric and the prior endorsement metric falls below the threshold difference, or
whether a difference between the current disapproval metric and the prior disapproval metric falls below the threshold difference.

4. The method of claim 2, wherein determining whether a current time period corresponds to an expected media item access time period for the client device based on the media item access history of the client device comprises:
identifying, for each of the first set of media items, a timestamp indicating a time during which the client device accessed the respective media item;
determining the expected media item access time period based on a range of the timestamps identified for each of the first set of media items; and
determining at least one of:
whether the current time period falls within the expected media item access time period, or
whether a distance between the current time period and one or more of the range of the timestamps falls below a threshold distance.

5. The method of claim 1, further comprising:
responsive to determining that the one or more embedding updated criteria are not satisfied, identifying media item access history data associated with a third set of media items accessed by the client device since the embedding was generated;
generating an updated embedding based on the identified media item access data; and
selecting an additional media item of the second set of media items not yet accessed by the client device based on the embedding.

6. The method of claim 5, wherein the media item access data comprises at least one of an identifier associated with one or more of the third set of media items, a duration of access to the one or more of the third set of media items by the client device, a category associated with the one or more of the third set of media items, one or more characteristics associated with content of the one or more of the third set of the media items, an indication of one or more user interactions with respect to the one or more of the third set of media items by the user associated with the client device, or an indication of one or more user reactions with respect to one or more of the third set of media items by the user.

7. The method of claim 1, wherein selecting the media item of the second set of media items not yet accessed by the client device based on the identified embedding comprises:
providing the embedding as an input to an artificial intelligence (AI) model;
obtaining one or more outputs of the AI model, wherein the one or more outputs comprise, for each of the second set of media items, engagement data indicating one or more of a user interaction with a respective media item of the second set of media items by the user of the client device or a user reaction with the respective media item; and
identifying, based on the obtained one or more outputs, the respective media item associated with engagement data that satisfies one or more engagement criteria.

8. The method of claim 1, further comprising:
obtaining media item access data for at least a portion of the first set of media items;
providing the obtained media item access data as input to an AI model;
obtaining one or more outputs of the AI model, wherein the one or more outputs comprise one or more embeddings and, for each of the one or more embeddings, a level of confidence that a respective embedding corresponds to the media item access history associated with the client device;
extracting, from the one or more outputs, the embedding having a level of confidence that satisfies one or more confidence criteria; and
storing the extracted embedding at a region of a memory associated with the client device, wherein the embedding is identified at the region of the memory.

9. The method of claim 1, wherein the media item of the second set of media items is further selected responsive to a request received from the client device to access one or more media items.

10. The method of claim 1, wherein the selected media item includes at least one of a short-form video item or a long-form video item.

11. The method of claim 1, wherein the second set of media items is associated with a first content sharing platform, and wherein each of the first set of media items is associated with at least one of the first content sharing platform or one or more second content sharing platforms.

12. A system comprising:
a memory; and
a processing device coupled to the memory, the processing device to perform operations comprising:
identifying an embedding that represents a media item access history associated with a client device with respect to a first set of media items previously accessed by one or more client devices associated with a user;
determining whether one or more embedding relevance criteria are satisfied with respect to the media item access history of the client device;
responsive to determining that the one or more embedding relevance criteria are satisfied, selecting a media item of a second set of media items not yet accessed by the client device based on the embedding; and
providing the client device with access to the selected media item.

13. The system of claim 12, wherein determining whether the one or more embedding relevance criteria are satisfied with respect to the media item access history of the client device comprises at least one of:
determining whether a difference between prior media item engagement data associated with the client device and current media item engagement data associated with the client device falls below a threshold difference;
determining whether a current time period corresponds to an expected media item access time period for the client device based on the media item access history of the client device;
determining whether a number of media items accessed by the client device after generation of the identified embedding falls below a threshold number of media items;
determining whether a number of requests to update an embedding associated with the client device falls below a threshold number; or
determining whether metadata for the embedding indicates that the identified embedding is invalid.

14. The system of claim 13, wherein determining whether a difference between prior media item engagement data associated with the client device and current media item engagement data associated with the client device falls below a threshold difference comprises:
extracting, from the prior media item engagement data, one or more of a prior endorsement metric indicating a number of the first set of media items endorsed by the user, or a prior disapproval metric indicating a number of the first set of media items disapproved by the user;
extracting, from the current media item engagement data, one or more of a current endorsement metric indicating a number a third set of media items endorsed by the user, the third set of media items accessed between the current time period and a prior time period during which the embedding was generated, or a current disapproval metric indicating a number of the third set of media items disapproved by the user; and
determining whether at least one of:
a difference between the current endorsement metric and the prior endorsement metric falls below the threshold difference, or
a difference between the current disapproval metric and the prior disapproval metric falls below the threshold difference.

15. The system of claim 13, wherein determining whether a current time period corresponds to an expected media item access time period for the client device based on the media item access history of the client device comprises:
identifying, for each of the first set of media items, a timestamp indicating a time during which the client device accessed the respective media item;
determining the expected media item access time period based on a range of the timestamps identified for each of the first set of media items; and
determining whether at least one of:
the current time period falls within the expected media item access time period, or a distance between the current time period and one or more of the range of the timestamps falls below a threshold distance.

16. The system of claim 12, wherein the operations further comprise:
responsive to determining that the one or more embedding updated criteria are not satisfied, identifying media item access history data associated with a third set of media items accessed by the client device since the embedding was generated;
generating an updated embedding based on the identified media item access data; and
selecting an additional media item of the second set of media items not yet accessed by the client device based on the embedding.

17. The system of claim 16, wherein the media item access data comprises at least one of an identifier associated with one or more of the third set of media items, a duration of access to the one or more of the third set of media items by the client device, a category associated with the one or more of the third set of media items, one or more characteristics associated with content of the one or more of the third set of the media items, an indication of one or more user interactions with respect to the one or more of the third set of media items by a user associated with the client device, or an indication of one or more user reactions with respect to one or more of the third set of media items by the user.

18. The system of claim 12, wherein selecting the media item of the second set of media items not yet accessed by the client device based on the identified embedding comprises:
providing the embedding as an input to an artificial intelligence (AI) model;
obtaining one or more outputs of the AI model, wherein the one or more outputs comprise, for each of the second set of media items, engagement data indicating one or more of a user interaction with a respective media item of the second set of media items by a user of the client device or a user reaction with the respective media item; and
identifying, based on the obtained one or more outputs, the respective media item associated with engagement data that satisfies one or more engagement criteria.

19. The system of claim 12, wherein the operations further comprise:
obtaining media item access data for at least a portion of the first set of media items;
providing the obtained media item access data as input to an AI model;
obtaining one or more outputs of the AI model, wherein the one or more outputs comprise one or more embeddings and, for each of the one or more embeddings, a level of confidence that a respective embedding corresponds to the media item access history associated with the client device;
extracting, from the one or more outputs, the embedding having a level of confidence that satisfies one or more confidence criteria; and
storing the extracted embedding at a region of a memory associated with the client device, wherein the embedding is identified at the region of the memory.

20. A non-transitory computer readable storage medium comprising instructions for a server that, when executed by a processing device, cause the processing device to perform operations comprising:
identifying an embedding that represents a media item access history associated with a client device with respect to a first set of media items previously accessed by one or more client devices associated with a user;
determining whether one or more embedding relevance criteria are satisfied with respect to the media item access history of the client device;
responsive to determining that the one or more embedding relevance criteria are satisfied, selecting a media item of a second set of media items not yet accessed by the client device based on the embedding; and
providing the client device with access to the selected media item.
